(19) United States
(12) Patent Application Publication
(10) Pub. No.: US 2017/0289558 A1
(43) Pub. Date: Oct. 5, 2017

(54) METHOD AND DEVICE FOR ALLOCATING A TRANSCODING TASK

(71) Applicants: Le Holdings (Beijing) Co., Ltd., Beijing (CN); Le Cloud Computing Co., Ltd, Beijing (CN)

(72) Inventors: Maosheng Bai, Beijing (CN); Chao Lv, Beijing (CN); Hai Qi, Beijing (CN); Wei Wei, Beijing (CN)

(73) Assignees: Le Holdings (Beijing) Co., Ltd., Beijing (CN); Le Cloud Computing Co., Ltd., Beijing (CN)

(21) Appl. No.: 15/246,330

(22) Filed: Aug. 24, 2016

Related U.S. Application Data
(63) Continuation of application No. PCT/CN2016/088989, filed on Jul. 6, 2016.

(30) Foreign Application Priority Data
Mar. 31, 2016 (CN) 201610201287.3

(51) Int. Cl. H04N 19/40; H04N 19/172; G06F 9/50; H04N 19/184

(52) U.S. Cl. CPC H04N 19/40; H04N 19/184; H04N 19/172; G06F 9/5083

(57) ABSTRACT

The disclosure discloses a method and device for allocating a transcoding task, the method including: obtaining the transcoding task to be allocated; determining the number of standard processing units to be occupied by the transcoding task to be allocated; obtaining current load states of respective transcoders; selecting a target transcoder according to the number of standard processing units to be occupied for the transcoding task to be allocated, and the current load states of the respective transcoders so that the load state of the target transcoder to which the transcoding task to be allocated has been added is still in a normal state; allocating the transcoding task to be allocated, to the target transcoder; and updating the current load state of the target transcoder.

### CROSS-REFERENCE TO RELATED APPLICATIONS

This application is a continuation of International Application No. PCT/CN2016/088989, filed on Jul. 6, 2016, which is based upon and claims priority to Chinese Patent Application No. 201610201287.3, filed on Mar. 31, 2016, the entire contents of which are incorporated herein by reference

### TECHNICAL FIELD

The present disclosure relates to the field of video transcoding, and particularly to a method and device for allocating a transcoding task.

### BACKGROUND

A video website converts various video resources into a format suitable for playing over the Internet so that a user can access the corresponding video website through a computer terminal, a mobile terminal, or an Internet enabled TV terminal to watch the various videos.

Since there may be different video formats of the different video resources, the videos need to be presented to the user at different definitions in order to adapt to scenarios different network bandwidths. Thus the video website needs to create transcoding tasks, and to execute the respective transcoding tasks through a transcoding system therein to transcode the videos.

In implanting the process of the disclosure, the inventors of the disclosure have found that there is at least the relevant technical problem: since a live video system is required to be highly real time as compared with a video on demand system, and the lowest encoding performance index of the real-time transcoding tasks shall be the encoding frame rate, so that if the existing solution to allocation of the transcoding tasks primarily for the video on demand system is applied to the live video system, then transcoding resources may not be distributed equally so that transcoding may be interrupted and/or a transcoder may be underutilized. Accordingly it is highly desirable to provide a simple and working allocation solution to real-time transcoding of videos with different video contents, different resolutions, different frame rates, and different bit rates.

### SUMMARY

An object of embodiments of the disclosure is to provide an innovative technical solution to allocation of transcoding tasks so as to improve the ability of a transcoding system to maintain high efficiency of transcoding.

According to a first aspect of the disclosure, there is provided a method for allocating a transcoding task, the method including:

obtaining the transcoding task to be allocated;

determining the number of standard processing units to be occupied by the transcoding task to be allocated;

obtaining current load states of respective transcoders, wherein the load state is set to be characterized as an occupancy ratio which is the proportion of the number of standard processing units occupied by transcoding tasks executed by a transcoder among the total number of standard processing units of the corresponding transcoder;

selecting a target transcoder according to the number of standard processing units to be occupied for the transcoding task to be allocated and the current load states of the respective transcoders, wherein the load state of the target transcoder to which the transcoding task to be allocated has been added is still in a normal state;

allocating the transcoding task to be allocated, to the target transcoder; and

updating the current load state of the target transcoder.

According to a second aspect of the disclosure, there is provided an electronic device, including:

at least one processor; and

a memory communicably connected with the at least one processor for storing instructions executable by the at least one processor, wherein execution of the instructions by the at least one processor causes the at least one processor to:

obtain the transcoding task to be allocated;

determine the number of standard processing units to be occupied by the transcoding task to be allocated;

obtain current load states of respective transcoders, wherein the load state is set to be characterized as an occupancy ratio which is the proportion of the number of standard processing units occupied by transcoding tasks executed by a transcoder among the total number of standard processing units of the corresponding transcoder;

select a target transcoder according to the number of standard processing units to be occupied for the transcoding task to be allocated and the current load states of the respective transcoders, wherein the load state of the target transcoder to which the transcoding task to be allocated has been added is still in a normal state;

allocate the transcoding task to be allocated, to the target transcoder; and

update the current load state of the target transcoder.

According to a third aspect of the disclosure, there is provided a non-transitory computer-readable storage medium storing executable instructions that, when executed by an electronic device with a touch-sensitive display, cause the electronic device to:

obtain the transcoding task to be allocated;

determine the number of standard processing units to be occupied by the transcoding task to be allocated;

obtain current load states of respective transcoders, wherein the load state is set to be characterized as an occupancy ratio which is the proportion of the number of standard processing units occupied by transcoding tasks executed by a transcoder among the total number of standard processing units of the corresponding transcoder;

select a target transcoder according to the number of standard processing units to be occupied for the transcoding task to be allocated and the current load states of the respective transcoders, wherein the load state of the target transcoder to which the transcoding task to be allocated has been added is still in a normal state;

allocate the transcoding task to be allocated, to the target transcoder; and

update the current load state of the target transcoder.

The inventors of the disclosure have identified such a problem in the prior art that transcoding resources may not be distributed equally so that transcoding may be interrupted and/or a transcoder may be underutilized. In the embodiments of the disclosure, the processing capacities of the transcoders, and the processing resources to be occupied by the transcoding tasks can be metered in the unified metering standard, i.e., standard processing units so that the real-time transcoding tasks can be allocated simply and efficiently to thereby improve the real-time characteristic of transcoding, and the utilization ratios of the respective transcoders

Exemplary embodiments of the disclosure will be described below in details with reference to the drawings so as to make other features of the disclosure, and their advantages become more apparent.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed:

FIG. 1 is a flow chart of a method for allocating a transcoding task in accordance with some embodiments;

FIG. 2 is a flow chart of some implementations of determining the number of standard processing units be occupied by the transcoding task to be allocated in FIG. 1;

FIG. 3 is a principle block diagram of a structure in which an apparatus for allocating a transcoding task in accordance with some embodiments is embodied;

FIG. 4 is a principle block diagram of a structure in which the resource occupancy determining module in FIG. 3;

FIG. 5 is a principle block diagram of another structure in which an apparatus for allocating a transcoding task in accordance with some embodiments is embodied;

FIG. 6 a schematic structural diagram of an electronic device in accordance with some embodiments.

### DETAILED DESCRIPTION

Various exemplary embodiments of the disclosure will be described below in details with reference to the drawings. It shall be noted that unless stated otherwise, relative arrangements of components and steps, numeral expressions, and values, which are set forth in these embodiments will not limit the scope of the disclosure.

The following description of at least one exemplary embodiment is merely illustrative indeed, but not intended to limit the disclosure and its applications or uses in any way.

Techniques, methods, and devices known to those skilled in the art may not be discussed in details, but shall be construed as a part of the specification if appropriate.

Any particular values throughout the examples illustrated and discussed here shall be constructed as merely illustrative, but not intended to be limiting. Accordingly there may be different values in other examples of the exemplary embodiments.

It shall be noted that like reference numerals and symbols will refer to like elements throughout the drawings, so if some element is defined in one of the drawings, then it will not be further discussed in subsequent drawings.

In order to address such a problem that transcoding resources may not be distributed equally so that transcoding may be interrupted and/or a transcoder may be underutilized, the disclosure provides an innovative technical solution to allocation of a transcoding task while ensuring real-time transcoding.

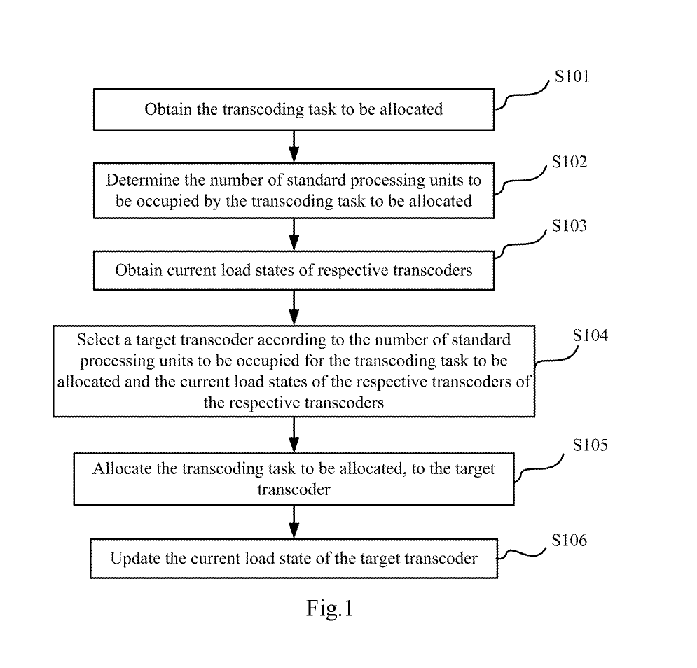

FIG. 1 is a flow chart of an embodiment of a method for allocating a transcoding task according to the disclosure.

As illustrated in FIG. 1, the method according to the disclosure includes the following operations:

The operation S101 is to obtain the transcoding task to be allocated.

Since the method of the disclosure can enable real-time transcoding to be real-time, the transcoding task to be allocated can be a live video-like real-time transcoding task, or of course, it can be alternatively be another type of transcoding task, e.g., a video on demand-like transcoding task.

The operation S102 is to determine the number of standard processing units to be occupied by the transcoding task to be allocated.

The standard processing unit is a unified metering standard applicable to the method of the disclosure, and in a real application, on one hand, a processing capacity of each transcoder is standardized in standard processing units, where there are typically different processing capacities of different transcoders; and on the other hand, processing resources to be occupied by respective transcoding tasks are metered in standard processing units, so that load states of the respective transcoders can be counted simply and efficiently in the unified standard.

The load state is set to be characterized as an occupancy ratio which is the proportion of the number of standard processing units occupied by transcoding tasks executed by a transcoder among the total number of standard processing units of the corresponding transcoder, where the proportion can be a ratio or a percentage. For example, if the total number of standard processing units of a transcoder is one million, and 300 thousands of standard processing units are occupied by all the current transcoding tasks being executed by the transcoder, then the current load state of the transcoder will be 30%.

The standard processing unit can be defined as a processing resource to be occupied for transcoding a dividing unit in a reference transcoding task at a specific resolution, that is, the processing resource to be occupied for transcoding the dividing unit in the reference transcoding task at the specific resolution can be denominated as a standard processing unit, where the specific resolution is 1080P, for example, but will not be limited thereto, and the dividing unit can be a macro block or a frame of data; and here since a video encoding algorithm is typically in units of macro blocks, where the respective macro blocks are encoded one by one into a continuous video code stream, the dividing unit is preferably set as a macro block. Thus in this particular embodiment, the largest number of macro blocks in the reference transcoding task at the resolution of 1080P which can be transcoded concurrently by each transcoder is the total number of available processing resources of the corresponding transcoder, where the largest number of macro blocks can be determined as a result of a pressure test. Hereupon the numbers of standard processing units to be occupied for dividing units in reference transcoding tasks at other resolutions can be standardized in advance, and particularly the numbers of standard processing units to be occupied for the dividing units in the reference transcoding tasks at the respective definitions to be standardized can be determined as the ratios of the largest numbers of macro blocks in the reference transcoding tasks at the resolution to be standardized which can be transcoded concurrently on the same transcoder to the largest numbers of macro blocks at the specific resolution which can be transcoded concurrently. For example, if there are one million standard processing units of a transcoder, and the ratio is 0.5, then there will be two standard processing units to be occupied for transcoding a dividing unit in a reference transcoding task at a resolution to be standardized; and here the bit rates and the frame rates of the reference transcoding task at the specific resolution may be identical or partially identical to or different from the bit rates and the frame rates of the reference transcoding tasks at the other resolutions.

The operation S103 is to obtain current load states of respective transcoders.

The current load state can be provided by the transcoder, or can be recorded and updated as transcoding tasks are allocated and finished.

In order to facilitate a search for the current load states of the respective transcoders, the current load states of the respective transcoders can be recorded in a linked table.

The operation S104 is to select a target transcoder according to the number of standard processing units to be occupied for the transcoding task to be allocated, and the current load states of the respective transcoders so that the load state of the destination transcoder to which the transcoding task to be allocated has been added is still in a normal state.

The normal state refers to such a state that the occupancy ratio does not exceed a preset upper limit of processing, which is 85%, for example.

The target transcoder can be selected by selecting a satisfactory target transcoder randomly, or by selecting a satisfactory target transcoder under such a low occupancy principle that a transcoder with lowest current load state is selected as the target transcoder, or a transcoder, to which the transcoding task to be allocated has been added, with the lowest load state is selected as the target transcoder, to thereby further improve the utilization ratios of the respective transcoders; or by selecting a satisfactory target transcoder according to transcoding task allocation priorities of the respective transcoders, where the respective transcoders are allocated with transcoding tasks to be preferentially allocated, according to the processing capacities thereof to thereby utilize reasonably the transcoders.

The operation S105 is to allocate the transcoding task to be allocated, to the target transcoder.

The operation S106 is to update the current load state of the target transcoder.

Here those skilled in the art shall appreciate that if a transcoder finishes a transcoding task, the current load state of the corresponding transcoder will be updated after a processing resource is released, and since the disclosure generally relates to allocation of a transcoding task, a detailed description of a process of releasing and updating a processing resource will be omitted here.

As can be apparent, in the disclosure, the processing capacities of the transcoders, and the processing resources to be occupied by the transcoding tasks can be standardized in standard processing units in a unified manner, and further the transcoding tasks can be allocated simply and efficiently, so that the respective transcoders can operate normally, thus avoiding the problem of interrupted transcoding and seriously unequal utilization ratios of the transcoders.

In order to lower the amount of standardization efforts, one resolution can be set corresponding to one reference transcoding task, and in operation, the number of standard processing units to be occupied for the transcoding task to be allocated can be calculated as a function of the differences between the bit rate and the frame rate of the transcoding task to be allocated, and the bit rate and the frame rate of the reference transuding task at the same resolution, so that only a small number of reference transcoding tasks will be standardized to thereby greatly lower the amount of data statistics efforts.

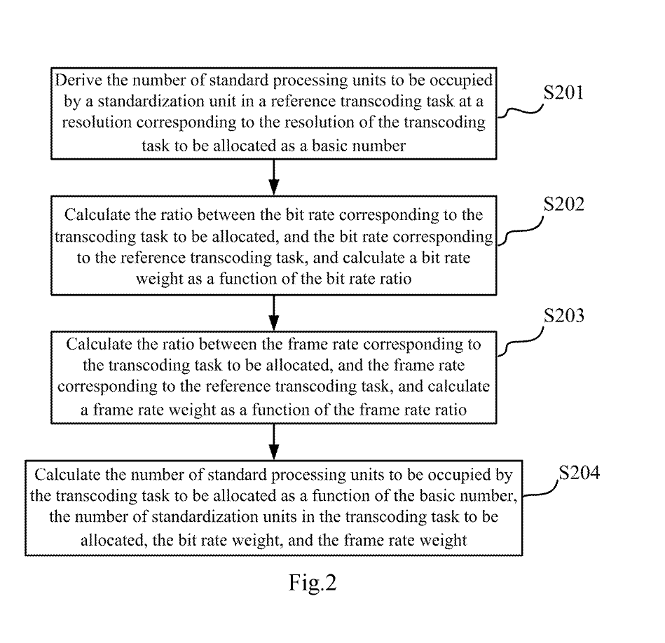

FIG. 2 is a particular flow chart of the operation S102 above in this operation mode.

As illustrated in FIG. 2, the number of standard processing units to be occupied by the transcoding task to be allocated can be further determined in the following operations:

The operation S201 is to derive the number of standard processing units to be occupied by a dividing unit in a reference transcoding task at a resolution corresponding to the resolution of the transcoding task to be allocated as a basic number.

In the operation S201, typically a reference table reflecting correspondence relationships between dividing units of reference transcoding tasks at respective resolutions, and the numbers of standard processing units to be occupied can be searched for the number of standard processing units to be occupied by the dividing unit in the reference transcoding task at a resolution corresponding to the resolution of the transcoding task to be allocated.

For a special resolution which is not listed in the reference table, the basic number can be derived through interpolation. The operation S202 is to calculate the ratio between the bit rate corresponding to the transcoding task to be allocated, and the bit rate corresponding to the reference transcoding task, and to calculate a bit rate weight as a function of the bit rate ratio.

A relationship between bit rate ratios and bit rate weights can be derived by fitting data measured in reality at the same resolution and different bit rates, e.g., linear fitting, polynomial fitting, parabolic fitting, etc. There are more useful data for parabolic fitting of the data measured in reality, where the resulting correspondence relationship between the bit rate weight y and the bit rate ratio x is y=0.02x²−0.20x+1.17.

The operation S203 is to calculate the ratio between the frame rate corresponding to the transcoding task to be allocated, and the frame rate corresponding to the reference transcoding task, and to calculate a frame rate weight as a function of the frame rate ratio.

A relationship between frame rate ratios and frame rate weights can be derived by fitting data measured in reality at different frame rates, e.g., linear fitting, polynomial fitting, parabolic fitting, etc. There are more useful data for linear fitting of the data measured in reality, where the frame rate weight is equal to the frame rate ratio as a result of fitting.

The operation S204 is to calculate the number of standard processing units to be occupied by the transcoding task to be allocated as a function of the basic number, the number of dividing units in the transcoding task to be allocated, the bit rate weight, and the frame rate weight.

The number of dividing units in the transcoding task to be allocated can be determined by firstly determining the number of dividing units in each frame of data at the corresponding resolution, i.e., the number of macro blocks in each frame of data at the corresponding resolution if the dividing unit is a macro block, and then obtaining the number of dividing units in the transcoding task to be allocated, according to the number of frames in the transcoding task to be allocated.

Hereupon the number of standard processing units to be occupied by the transcoding task to be allocated can be derived by multiplying together the basic number, the number of dividing units in the transcoding task to be allocated, the bit rate weight, and the frame rate weight.

If the numbers of standard processing units to be occupied by the reference transcoding task of each macro block at the respective resolutions are standardized, then the numbers of standard processing units to be occupied by the reference transcoding tasks at the corresponding resolutions will be calculated according to the numbers of macro blocks in each frame of data at the corresponding resolutions.

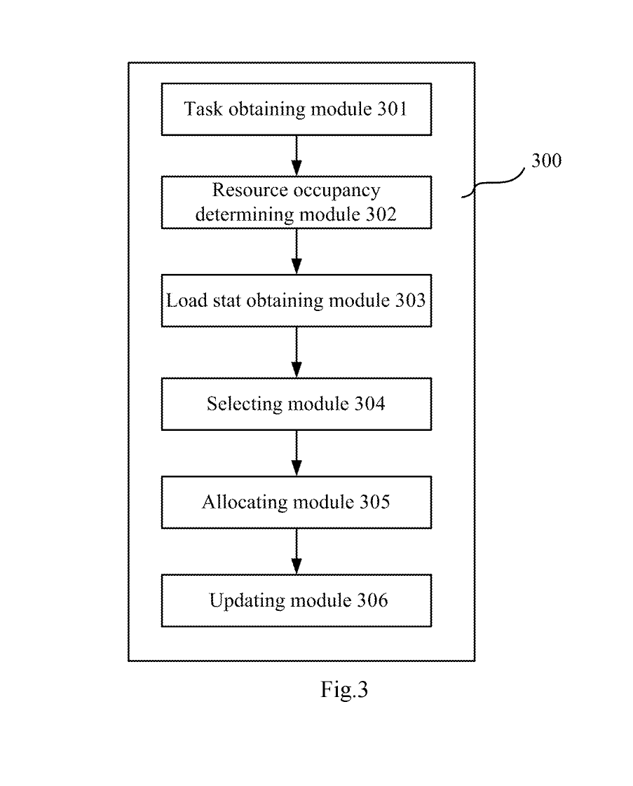

An embodiment of the disclosure further provides an apparatus for allocating a transcoding task, and FIG. 3 is a principle block diagram of a structure in which the apparatus according to an aspect of the disclosure is embodied.

As illustrated in FIG. 3 the apparatus 300 includes a task obtaining module 301, a resource occupancy determining module 302, a load state obtaining module 303, a selecting module 304, an allocating module 305, and a updating module 306.

The task obtaining module 301 is configured to obtain the transcoding task to be allocated.

The resource occupancy determining module 302 is configured to determine the number of standard processing units to be occupied by the transcoding task to be allocated.

The load state obtaining module 303 is configured to obtain current load states of respective transcoders, where the load state is set to be characterized as an occupancy ratio which is the proportion of the number of standard processing units occupied by transcoding tasks executed by a transcoder among the total number of standard processing units of the corresponding transcoder.

The selecting module 304 is configured to select a target transcoder according to the number of standard processing units to be occupied for the transcoding task to be allocated, and the current load states of the respective transcoders so that the load state of the target transcoder to which the transcoding task to be allocated has been added is still in a normal state.

The allocating module 305 is configured to allocate the transcoding task to be allocated, to the target transcoder.

The updating module 306 is configured to update the current load state of the target transcoder.

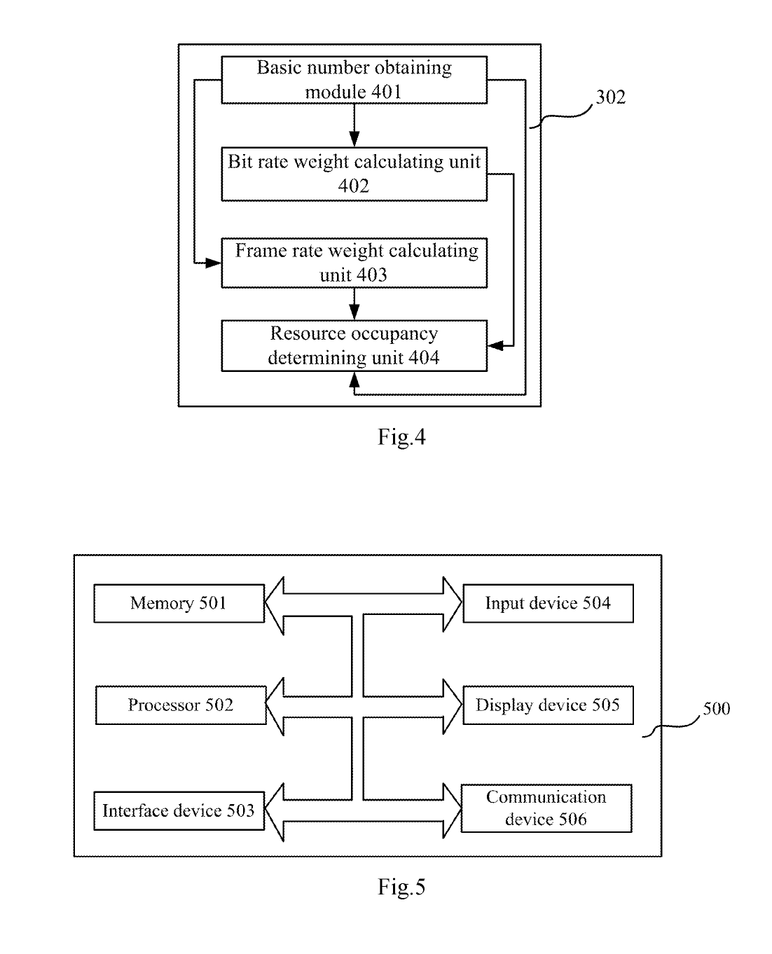

FIG. 4 is a principle block diagram of a structure in which the resource occupancy determining module 302 is embodied.

As illustrated in FIG. 4, the resource occupancy determining module 302 further includes a basic number obtaining module 401, a bit rate weight calculating unit 402, a frame rate weight calculating unit 403, and a resource occupancy determining unit 404.

The basic number obtaining module 401 is configured to derive the number of standard processing units to be occupied by a dividing unit in a reference transcoding task at a resolution corresponding to the resolution of the transcoding task to be allocated as a basic number.

The bit rate weight calculating unit 402 is configured to calculate the ratio between the bit rate corresponding to the transcoding task to be allocated, and the bit rate corresponding to the reference transcoding task, and to calculate a bit rate weight as a function of the bit rate ratio.

The frame rate weight calculating unit 403 is configured to calculate the ratio between the frame rate corresponding to the transcoding task to be allocated, and the frame rate corresponding to the reference transcoding task, and to calculate a frame rate weight as a function of the frame rate ratio.

The resource occupancy determining unit 404 is configured to calculate the number of standard processing units to be occupied by the transcoding task to be allocated, as a function of the basic number, the number of dividing units in the transcoding task to be allocated, the bit rate weight, and the frame rate weight.

The basic number obtaining module 401 can be configured to determine the number of standard processing units to be occupied by the dividing unit in the reference transcoding task at the corresponding resolution as the basic number by typically searching a reference table reflecting correspondence relationships between dividing units of reference transcoding tasks at respective resolutions, and the numbers of standard processing units to be occupied.

The selecting module 304 can be particularly configured to select the target transcoder under such a low occupancy principle that a transcoder with lowest current load state is selected as the target transcoder, or a transcoder, to which the transcoding task to be allocated has been added, with the lowest load state is selected as the target transcoder.

FIG. 5 is a principle block diagram of a structure in which the apparatus according to another aspect of the disclosure is embodied.

As illustrated in FIG. 5, the apparatus includes a memory 501 and a processor 502, where the memory 501 is configured to store instructions configured to control the processor 502 to operate to perform the method above for allocating a transcoding task.

Additionally as illustrated in FIG. 5, the apparatus can further include an interface device 503, an input device 504, a display device 505, a communication device 506, etc. Although a number of devices are illustrated in FIG. 5, the disclosure may only relate to a part of the devices, e.g., the processor 502, the processor 501, etc.

The communication device 506 can communicate in a wired or wireless mode, for example,

The interface device 503 includes a USB interface, an RS232 interface, an RS485 interface, etc., for example.

The input device 504 can include a touch screen, a button, etc., for example.

The display device 505 is a liquid crystal display screen, a touch display screen, etc., for example.

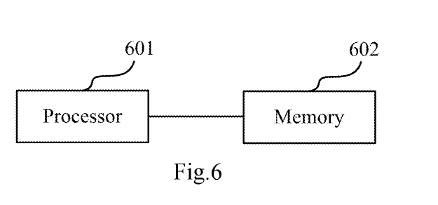

FIG. 6 illustrates a schematic structural diagram of an electronic device in accordance with some embodiments, wherein the electronic device includes:

at least one processor 601; and

a memory 602 communicably connected with the at least one processor for storing instructions executable by the at least one processor, wherein execution of the instructions by the at least one processor causes the at least one processor to:

obtain the transcoding task to be allocated;

determine the number of standard processing units to be occupied by the transcoding task to be allocated;

obtain current load states of respective transcoders, wherein the load state is set to be characterized as an occupancy ratio which is the proportion of the number of standard processing units occupied by transcoding tasks executed by a transcoder among the total number of standard processing units of the corresponding transcoder;

select a target transcoder according to the number of standard processing units to be occupied for the transcoding task to be allocated and the current load states of the respective transcoders, wherein the load state of the target transcoder to which the transcoding task to be allocated has been added is still in a normal state;

allocate the transcoding task to be allocated, to the target transcoder; and

update the current load state of the target transcoder.

In some embodiments, the determine the number of standard processing units to be occupied by the transcoding task to be allocated comprises:

obtain the number of standard processing units to be occupied by a dividing unit in a reference transcoding task at a resolution corresponding to the resolution of the transcoding task to be allocated as a basic number;

calculate the bit rate ratio between the bit rate corresponding to the transcoding task to be allocated, and the bit rate corresponding to the reference transcoding task, and calculate a bit rate weight as a function of the bit rate ratio;

calculate the frame rate ratio between the frame rate corresponding to the transcoding task to be allocated, and the frame rate corresponding to the reference transcoding task, and calculate a frame rate weight as a function of the frame rate ratio; and

calculate the number of standard processing units to be occupied by the transcoding task to be allocated, as a function of the basic number, the number of dividing units in the transcoding task to be allocated, the bit rate weight, and the frame rate weight.

In some embodiments, the obtain the number of standard processing units to be occupied by a dividing unit in a reference transcoding task at a resolution corresponding to the resolution of the transcoding task to be allocated as a basic number comprises:

determine the number of standard processing units to be occupied by the dividing unit in the reference transcoding task at the corresponding resolution by searching a reference table reflecting correspondence relationships between dividing units of reference transcoding tasks at respective resolutions, and the numbers of standard processing units to be occupied.

In some embodiments, execution of the instructions by the at least one processor further causes the at least one processor to: calculate the frame rate weight equal to the frame rate ratio.

In some embodiments, execution of the instructions by the at least one processor further causes the at least one processor to:

select the target transcoder under such a low occupancy principle that a transcoder with lowest current load state is selected as the target transcoder, or a transcoder, to which the transcoding task to be allocated has been added, with the lowest load state is selected as the target transcoder.

An embodiment of the disclosure provides a non-transitory computer-readable storage medium storing executable instructions that, when executed by an electronic device with a touch-sensitive display, cause the electronic device to:

obtain the transcoding task to be allocated;

determine the number of standard processing units to be occupied by the transcoding task to be allocated;

obtain current load states of respective transcoders, wherein the load state is set to be characterized as an occupancy ratio which is the proportion of the number of standard processing units occupied by transcoding tasks executed by a transcoder among the total number of standard processing units of the corresponding transcoder;

select a target transcoder according to the number of standard processing units to be occupied for the transcoding task to be allocated and the current load states of the respective transcoders, wherein the load state of the target transcoder to which the transcoding task to be allocated has been added is still in a normal state;

allocate the transcoding task to be allocated, to the target transcoder; and

update the current load state of the target transcoder.

In some embodiments, the determine the number of standard processing units to be occupied by the transcoding task to be allocated includes:

obtain the number of standard processing units to be occupied by a dividing unit in a reference transcoding task at a resolution corresponding to the resolution of the transcoding task to be allocated as a basic number;

calculate the bit rate ratio between the bit rate corresponding to the transcoding task to be allocated, and the bit rate corresponding to the reference transcoding task, and calculate a bit rate weight as a function of the bit rate ratio;

calculate the frame rate ratio between the frame rate corresponding to the transcoding task to be allocated, and the frame rate corresponding to the reference transcoding task, and calculate a frame rate weight as a function of the frame rate ratio; and

calculate the number of standard processing units to be occupied by the transcoding task to be allocated, as a function of the basic number, the number of dividing units in the transcoding task to be allocated, the bit rate weight, and the frame rate weight.

In some embodiments, the obtain the number of standard processing units to be occupied by a dividing unit in a reference transcoding task at a resolution corresponding to the resolution of the transcoding task to be allocated as a basic number includes:

determine the number of standard processing units to be occupied by the dividing unit in the reference transcoding task at the corresponding resolution by searching a reference table reflecting correspondence relationships between dividing units of reference transcoding tasks at respective resolutions, and the numbers of standard processing units to be occupied.

In some embodiments, the non-transitory computer-readable storage medium further cause the electronic device to:

select the target transcoder under such a low occupancy principle that a transcoder with lowest current load state is selected as the target transcoder, or a transcoder, to which the transcoding task to be allocated has been added, with the lowest load state is selected as the target transcoder.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The respective embodiments above have been described by focusing on their differences from the other embodiments, but those skilled in the art shall appreciate that the respective embodiments above can be applied separately or in combination as needed.

The respective embodiments in the specification have been described progressively, each of the embodiments has been described by focusing on its differences from the other embodiments, and the description of their commonalities can be applied to each other. However those skilled in the art shall appreciate that the respective embodiments can be applied separately or in combination as needed. Moreover the embodiments of the apparatus correspond to the embodiments of the method, so the embodiments of the apparatus have been described in brevity, and reference can be made to the description of the corresponding components in the embodiments of the method for details of those components in the embodiments of the apparatus. The embodiments of the apparatus have been described above merely by way of an example, and the modules described as separate components may or may not be physically separate.

The disclosure can be embodied as an apparatus, a method, and/or a computer program product. The computer program product can include a computer readable storage medium on which computer readable program instructions for causing a processor to implement the respective aspects of the disclosure are carried.

The computer readable storage medium can be a tangible device which can hold and store instructions for use by an instruction executing device. The computer readable storage medium can be, for example, but will not be limited to an electronic storage device, a magnetic storage device, an optical storage device, an electromagnetic storage device, a semiconductor storage device, or any appropriate combination thereof. More particular examples (a non-exhaust listing) of the computer readable storage medium include a portable computer disk, a hard disc, an Random Access Memory (RAM), a Read Only Memory (ROM), an Erasable Programmable Read Only Memory (EPROM) or a flash memory, a Static Random Access Memory (SRAM), a Compact Disk-Read Only Memory (CD-ROM), a Digital Versatile Disc (DVD), a memory stick, a floppy disk, a mechanically encoded device, e.g., a punched card, or a protrusion structure in a concave groove, on which instructions are stored, and any appropriate combination thereof. The computer readable storage medium as referred here to shall not be construed as an instantaneous signal per se, e.g., a radio wave, or another electromagnetic wave propagating freely, an electromagnetic wave propagating through a waveguide or another transmission medium (e.g., a light pulse propagating through an optic fiber cable), or an electronic signal transmitted over a wire.

The computer readable program instructions as referred here to can be downloaded from the computer readable storage medium to respective computing/processing devices or to external computers or external storage devices over a network, e.g., the Internet, a local area network, a wide area network and/or a wireless network. The network can include a copper transmission cable, optic fiber transmission, radio transmission, a router, a firewall, a switch, a gateway computer, and/or an edge server. A network adaptation card or a network interface in each computing/processing device receives the computer readable program instructions from the network, and forwards the computer readable program instructions for storage in the computer readable storage mediums in the respective computing/processing devices.

The computer readable program instructions for performing the operations of the disclosure can be source codes or object codes written in assembling instructions, Instruction Set Architecture (ISA) instructions, machine instructions, machine related instructions, micro codes, firmware instructions, state setting data, or any combination of one or more programming languages including an object oriented programming language, such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, an electronic circuit can be customized individually using state information of the computer readable program instructions, e.g., a programmable logic circuit, a Field programmable Gate Array (FPGA), or a Programmable Logic Array (PLA), where the electronic circuit can execute the computer readable program instructions to thereby implement the respective aspects of the disclosure.

Aspects of the present disclosure have been described here with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. As well known to those skilled in the art, an implementation in hardware, an implementation in software, and an implementation in both hardware and software may be equivalent to each other.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The scope of the disclosure shall be as defined in the appended claims.

1-12. (canceled)

13. A method for allocating a transcoding task, the method comprising:
obtaining the transcoding task to be allocated;
determining the number of standard processing units to be occupied by the transcoding task to be allocated;
obtaining current load states of respective transcoders, wherein the load state is set to be characterized as an occupancy ratio which is the proportion of the number of standard processing units occupied by transcoding tasks executed by a transcoder among the total number of standard processing units of the corresponding transcoder;
selecting a target transcoder according to the number of standard processing units to be occupied for the transcoding task to be allocated and the current load states of the respective transcoders, wherein the load state of the target transcoder to which the transcoding task to be allocated has been added is still in a normal state;
allocating the transcoding task to be allocated, to the target transcoder; and
updating the current load state of the target transcoder.

14. The method according to claim 13, wherein the determining the number of standard processing units to be occupied by the transcoding task to be allocated comprises:
obtaining the number of standard processing units to be occupied by a dividing unit in a reference transcoding task at a resolution corresponding to the resolution of the transcoding task to be allocated as a basic number;
calculating the bit rate ratio between the bit rate corresponding to the transcoding task to be allocated, and the bit rate corresponding to the reference transcoding task, and calculating a bit rate weight as a function of the bit rate ratio;
calculating the frame rate ratio between the frame rate corresponding to the transcoding task to be allocated, and the frame rate corresponding to the reference transcoding task, and calculating a frame rate weight as a function of the frame rate ratio; and
calculating the number of standard processing units to be occupied by the transcoding task to be allocated as a function of the basic number, the number of dividing units in the transcoding task to be allocated, the bit rate weight, and the frame rate weight.

15. The method according to claim 14, wherein the obtaining the number of standard processing units to be occupied by the dividing unit in the reference transcoding task at a resolution corresponding to the resolution of the transcoding task to be allocated as the basic number comprises:
determining the number of standard processing units to be occupied by the dividing unit in the reference transcoding task at the corresponding resolution by searching a reference table reflecting correspondence relationships between dividing units of reference transcoding tasks at respective resolutions, and the numbers of standard processing units to be occupied.

16. The method according to claim 14, wherein the calculating the frame rate weight as a function of the frame rate ratio comprises:
calculating the frame rate weight equal to the frame rate ratio.

17. The method according to claim 14, wherein the dividing unit is a macro block.

18. The method according to claim 13, wherein the selecting the target transcoder comprises:
selecting the target transcoder under such a low occupancy principle that a transcoder with lowest current load state is selected as the target transcoder, or a transcoder, to which the transcoding task to be allocated has been added, with the lowest load state is selected as the target transcoder.

19. An electronic device, comprising:
at least one processor; and
a memory communicably connected with the at least one processor for storing instructions executable by the at least one processor, wherein execution of the instructions by the at least one processor causes the at least one processor to:
obtain the transcoding task to be allocated;
determine the number of standard processing units to be occupied by the transcoding task to be allocated;
obtain current load states of respective transcoders, wherein the load state is set to be characterized as an occupancy ratio which is the proportion of the number of standard processing units occupied by transcoding tasks executed by a transcoder among the total number of standard processing units of the corresponding transcoder;
select a target transcoder according to the number of standard processing units to be occupied for the transcoding task to be allocated and the current load states of the respective transcoders, wherein the load state of the target transcoder to which the transcoding task to be allocated has been added is still in a normal state;
allocate the transcoding task to be allocated, to the target transcoder; and
update the current load state of the target transcoder.

20. The electronic device according to claim 19, wherein the determine the number of standard processing units to be occupied by the transcoding task to be allocated comprises:
obtain the number of standard processing units to be occupied by a dividing unit in a reference transcoding task at a resolution corresponding to the resolution of the transcoding task to be allocated as a basic number;
calculate the bit rate ratio between the bit rate corresponding to the transcoding task to be allocated, and the bit rate corresponding to the reference transcoding task, and calculate a bit rate weight as a function of the bit rate ratio;
calculate the frame rate ratio between the frame rate corresponding to the transcoding task to be allocated, and the frame rate corresponding to the reference transcoding task, and calculate a frame rate weight as a function of the frame rate ratio; and
calculate the number of standard processing units to be occupied by the transcoding task to be allocated, as a function of the basic number, the number of dividing units in the transcoding task to be allocated, the bit rate weight, and the frame rate weight.

21. The electronic device according to claim 20, wherein the obtain the number of standard processing units to be occupied by a dividing unit in a reference transcoding task at a resolution corresponding to the resolution of the transcoding task to be allocated as a basic number comprises:
determine the number of standard processing units to be occupied by the dividing unit in the reference transcoding task at the corresponding resolution by searching a reference table reflecting correspondence relationships between dividing units of reference transcoding tasks at respective resolutions, and the numbers of standard processing units to be occupied.

22. The electronic device according to claim 20, wherein execution of the instructions by the at least one processor further causes the at least one processor to: calculate the frame rate weight equal to the frame rate ratio.

23. The electronic device according to claim 19, wherein execution of the instructions by the at least one processor further causes the at least one processor to:
select the target transcoder under such a low occupancy principle that a transcoder with lowest current load state is selected as the target transcoder, or a transcoder, to which the transcoding task to be allocated has been added, with the lowest load state is selected as the target transcoder.

24. A non-transitory computer-readable storage medium storing executable instructions that, when executed by an electronic device with a touch-sensitive display, cause the electronic device to:
obtain the transcoding task to be allocated;
determine the number of standard processing units to be occupied by the transcoding task to be allocated;
obtain current load states of respective transcoders, wherein the load state is set to be characterized as an occupancy ratio which is the proportion of the number of standard processing units occupied by transcoding tasks executed by a transcoder among the total number of standard processing units of the corresponding transcoder;
select a target transcoder according to the number of standard processing units to be occupied for the transcoding task to be allocated and the current load states of the respective transcoders, wherein the load state of the target transcoder to which the transcoding task to be allocated has been added is still in a normal state;
allocate the transcoding task to be allocated, to the target transcoder; and
update the current load state of the target transcoder.

25. The non-transitory computer-readable storage medium according to claim 24, wherein the determine the number of standard processing units to be occupied by the transcoding task to be allocated comprises:
obtain the number of standard processing units to be occupied by a dividing unit in a reference transcoding task at a resolution corresponding to the resolution of the transcoding task to be allocated as a basic number;
calculate the bit rate ratio between the bit rate corresponding to the transcoding task to be allocated, and the bit rate corresponding to the reference transcoding task, and calculate a bit rate weight as a function of the bit rate ratio;
calculate the frame rate ratio between the frame rate corresponding to the transcoding task to be allocated, and the frame rate corresponding to the reference transcoding task, and calculate a frame rate weight as a function of the frame rate ratio; and
calculate the number of standard processing units to be occupied by the transcoding task to be allocated, as a function of the basic number, the number of dividing units in the transcoding task to be allocated, the bit rate weight, and the frame rate weight.

26. The non-transitory computer-readable storage medium according to claim 25, wherein the obtain the number of standard processing units to be occupied by a dividing unit in a reference transcoding task at a resolution corresponding to the resolution of the transcoding task to be allocated as a basic number comprises:
determine the number of standard processing units to be occupied by the dividing unit in the reference transcoding task at the corresponding resolution by searching a reference table reflecting correspondence relationships between dividing units of reference transcoding tasks at respective resolutions, and the numbers of standard processing units to be occupied.

27. The non-transitory computer-readable storage medium according to claim 25, further cause the electronic device to:
calculate the frame rate weight equal to the frame rate ratio.

28. The non-transitory computer-readable storage medium according to claim 24, further cause the electronic device to:
select the target transcoder under such a low occupancy principle that a transcoder with lowest current load state is selected as the target transcoder, or a transcoder, to which the transcoding task to be allocated has been added, with the lowest load state is selected as the target transcoder.
